(19) United States
(12) Patent Application Publication
(10) Pub. No.: US 2026/0079727 A1
(43) Pub. Date: Mar. 19, 2026

(54) ENVIRONMENT AND AUDIO-AWARE SPEAKER NOTES FOR A VIRTUAL MEETING

(71) Applicant: Google LLC, Mountain View, CA (US)

(72) Inventors: Kathleen Alexandra Bryan, New York, NY (US); Shiblee Imtiaz Hasan, Santa Clara, CA (US)

(21) Appl. No.: 18/890,615

(22) Filed: Sep. 19, 2024

(51) Int. Cl. G06F 9/451; H04N 7/15

(52) U.S. Cl. CPC G06F 9/451; H04N 7/15

(57) ABSTRACT

A method for environment- and audio-aware speaker notes for a virtual meeting includes causing a virtual meeting UI to be presented during a virtual meeting. The method includes identifying a first speaker note associated with content shared by a first participant of the during the virtual meeting. The method includes determining, using a first AI model and using a representation of the virtual meeting UI as input to the first AI model, a location in the virtual meeting UI for displaying the first speaker note. The method includes causing the virtual meeting UI to display, on a client device of the first participant, the first speaker note at the determined location in the virtual meeting UI.

### TECHNICAL FIELD

Aspects and implementations of the present disclosure relate to virtual meetings and more specifically to providing environment- and audio-aware speaker notes for a virtual meeting.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method. The method includes causing a virtual meeting user interface (UI) to be presented during a virtual meeting between one or more participants. The virtual meeting UI may include one or more first regions each corresponding to a participant of the one or more participants. The method includes identifying a first speaker note associated with content shared by a first participant of the one or more participants during the virtual meeting. The method includes determining, using a first artificial intelligence (AI) model and using a representation of the virtual meeting UI as input to the first AI model, a location in the virtual meeting UI for displaying the first speaker note. The method includes causing the virtual meeting UI to display, on a client device of the first participant, the first speaker note at the determined location in the virtual meeting UI.

Another aspect of the disclosure provides a system. The system includes a memory and a processing device coupled with the memory. The processing device is configured to perform operations. The operations include causing a virtual meeting UI to be presented during a virtual meeting between one or more participants. The virtual meeting UI may include one or more first regions each corresponding to a participant of the one or more participants. The operations include identifying a first speaker note associated with content shared by a first participant of the one or more participants during the virtual meeting. The operations include determining, using a first AI model and using a representation of the virtual meeting UI as input to the first AI model, a location in the virtual meeting UI for displaying the first speaker note. The operations include causing the virtual meeting UI to display, on a client device of the first participant, the first speaker note at the determined location in the virtual meeting UI.

Another aspect of the disclosure provides a non-transitory computer-readable storage medium with instructions that, when executed by a processing device, causes the processing device to perform operations. The operations include causing a virtual meeting UI to be presented during a virtual meeting between one or more participants. The virtual meeting UI may include one or more first regions each corresponding to a participant of the one or more participants. The operations include identifying a first speaker note associated with content shared by a first participant of the one or more participants during the virtual meeting. The operations include determining, using a first AI model and using a representation of the virtual meeting UI as input to the first AI model, a location in the virtual meeting UI for displaying the first speaker note. The operations include causing the virtual meeting UI to display, on a client device of the first participant, the first speaker note at the determined location in the virtual meeting UI.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for environment- and audio-aware speaker notes for a virtual meeting, in accordance with some implementations of the present disclosure.

FIG. 2 illustrates a schematic block diagram for an artificial intelligence (AI) training subsystem of a virtual meeting platform, in accordance with some implementations of the present disclosure.

FIG. 3 illustrates a schematic block diagram for an AI inference subsystem of a virtual meeting platform, in accordance with some implementations of the present disclosure.

FIG. 4 depicts a flow diagram of a method for environment- and audio-aware speaker notes for a virtual meeting, in accordance with some implementations of the present disclosure.

FIG. 5 depicts an example virtual meeting user interface (UI), in accordance with some implementations of the present disclosure.

FIG. 6 depicts another example virtual meeting UI, in accordance with some implementations of the present disclosure.

FIG. 7 is a block diagram illustrating an example computer system, in accordance with some implementations of the present disclosure.

### DETAILED DESCRIPTION

Aspects of the present disclosure relate to providing environment- and audio-aware speaker notes for a virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In some virtual meetings, a participant may prepare speaker notes before the virtual meeting. For example, the participant may be a speaker during a session of a conference that is held using the virtual meeting, or the participant may be a panelist during a panel held using the virtual meeting. This participant may be referred to as a “speaker participant.” Conventionally, during the virtual meeting, the speaker notes appear at a bottom of a display screen that the speaker participant uses or on a separate screen from the virtual meeting's UI. This presents several disadvantages. For example, in order to view the speaker notes, the speaker participant should look at the bottom of the display screen or at the separate screen, which breaks the speaker participant's eye contact with the speaker participant's camera and causes the speaker participant to look in an awkward direction. This can feel uncomfortable for the speaker participant and degrades the virtual meeting experience for other participants of the virtual meeting. Additionally, the speaker notes are static and do not adapt to occurrences during the virtual meeting.

Implementations of the present disclosure address the above and other deficiencies by providing a virtual meeting platform that uses artificial intelligence (AI) to determine where to place the speaker notes in the virtual meeting UI. The virtual meeting platform can place the speaker notes so the speaker participant does not break eye contact with the participant's camera and so the speaker notes do not cover up important portions of the virtual meeting UI (e.g., a slide presentation the speaker participant is presenting using the virtual meeting UI). Furthermore, the virtual meeting platform can use changing data about relevant conditions during the virtual meeting to modify the speaker notes during the virtual meeting. For example, the virtual meeting platform can use a transcript of the virtual meeting as input to an AI model, and the AI model can detect, using the transcript, that the speaker participant has already discussed a topic related to a certain speaker note. In response, the virtual meeting platform can mark the speaker note as covered (e.g., by crossing out the speaker note when it is presented on the speaker participant's virtual meeting UI) so that the speaker participant does not repeat a discussion of the speaker note and improves the flow of the virtual meeting.

Aspects of the present disclosure provide technical advantages over previous solutions. One technical problem of virtual meetings is the presentation of speaker notes in disadvantageous areas of the virtual meeting UI. Aspects of the present disclosure can provide a virtual meeting UI that uses AI to automatically present speaker notes in an area of the virtual meeting UI that the speaker participant can see without looking away from the participant's camera or blocking the participant's view of important areas of the virtual meeting UI. Another technical problem of virtual meetings is the static nature of the speaker notes. Aspects of the present disclosure can provide a virtual meeting UI that uses AI to automatically modify speaker notes for the speaker participant to adjust to changing conditions during the virtual meeting. Thus, aspects of the present disclosure improve the virtual meeting experience for both the speaker participant and other participants of the virtual meeting.

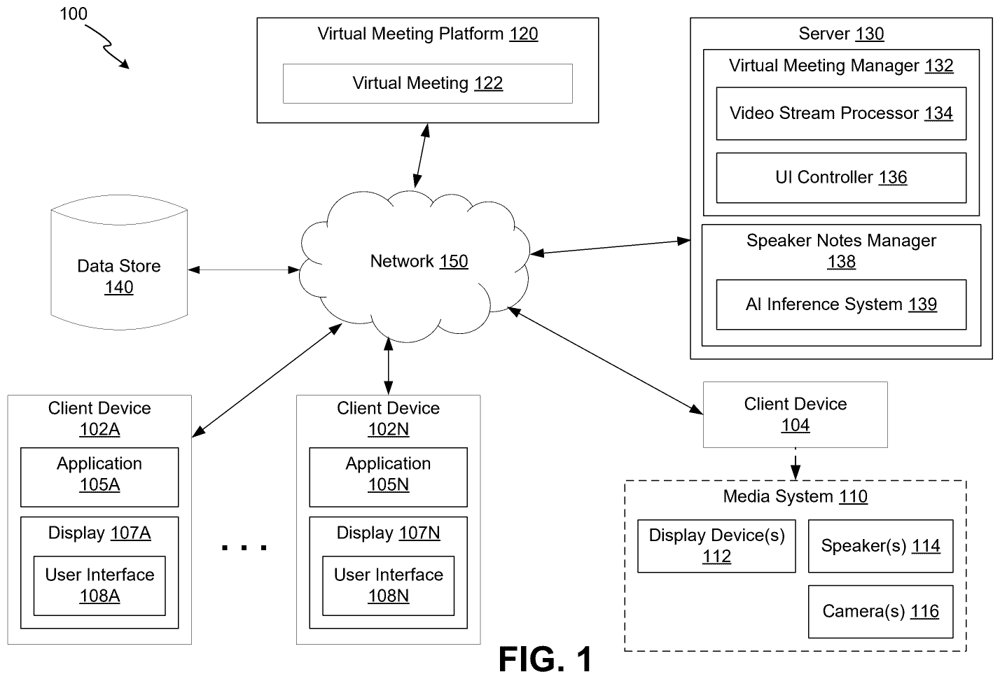

FIG. 1 illustrates an example system architecture 100, in accordance with implementations of the present disclosure. The system architecture 100 includes one or more client devices 102A-N or 104, a virtual meeting platform 120, a server 130, and a data store 140, each connected to a network 150.

In some implementations, the virtual meeting platform 120 enables users of one or more of the client devices 102A-N, 104 to connect with each other in a virtual meeting (e.g., a virtual meeting 122). A virtual meeting 122 refers to a real-time communication session such as a video-based call or video chat, in which participants can connect with multiple additional participants in real-time and be provided with audio and video capabilities. A virtual meeting 122 may include an audio-based call or chat, in which participants connect with multiple additional participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants” or, simply, “participants”). Implementations of the present disclosure can be implemented with any number of participants connecting via the virtual meeting 122 (e.g., up to one hundred or more).

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the virtual meeting platform 120 or the virtual meeting manager 132 collects user information (e.g., information about a user's social network, social actions or activities, profession, a user's preferences, or a user's current location), or to control whether or how to receive content from the virtual meeting platform 120 or the virtual meeting manager 132 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 or the virtual meeting manager 132.

In some implementations, the server 130 includes a virtual meeting manager 132. The virtual meeting manager 132, in one or more implementations, is configured and/or otherwise programmed to manage a virtual meeting 122 between multiple users of the virtual meeting platform 120. The virtual meeting manager 132 can provide the UIs 108A-N to each client device 102A-N, 104 to enable users to watch and listen to each other during a virtual meeting 122. The virtual meeting manager 132 can also collect and provide data associated with the virtual meeting 122 to each participant of the virtual meeting 122. In some implementations, the virtual meeting manager 132 provides the UIs 108A-N for presentation by client applications 105A-N. For example, the respective UIs 108A-N can be displayed on the display devices 107A-N by the client applications 105A-N executing on the operating systems of the client devices 102A-N, 104. In some implementations, the virtual meeting manager 132 determines visual items for presentation in the UIs 108A-N during a virtual meeting. A visual item can refer to a UI element that occupies a particular region in the UI and is dedicated to presenting a video stream from a respective client device. Such a video stream can depict, for example, a user of the respective client device 102A-N, 104 while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 132 includes a video stream processor 134 and a UI controller 136. Each of the video stream processor 134 or the UI controller 136 may include a software application (or a subset thereof) that performs certain virtual meeting functionality for the virtual meeting manager 132. The video stream processor 134 may be configured and/or otherwise programmed to receive video streams from one or more of the client devices 102A-N, 104. The video stream processor 134 may be configured and/or otherwise programmed to determine visual items for presentation in the UI of such client devices 102A-N, 104 (e.g., the UIs 108-108N, discussed below) during the virtual meeting 122. Each visual item can correspond to a video stream from a client device 102A-N, 104 (e.g., the video stream pertaining to one or more participants of the virtual meeting 122). In some implementations, the video stream processor 134 receives audio streams associated with the video streams from the client devices (e.g., from an audiovisual component of the client devices 102A-N, 104). Once the video stream processor 134 has determined visual items for presentation in the UI, the video stream processor 134 can notify the UI controller 136 of the determined visual items. The visual items for presentation can be determined based on current speaker, current presenter, order of the participants joining the virtual meeting 122, list of participants (e.g., alphabetical), etc.

In some implementations, the UI controller 136 provides the UI for the virtual meeting 122 (e.g., the UI 108A-N). The UI can include multiple regions. Each region can include a visual item to represent a video stream pertaining to one or more participants of the virtual meeting 122. The UI controller 136 can control which video stream is to be displayed by providing a command to one or more client devices 102A-N, 104 that indicates which video stream is to be used for which region of the UI (along with the received video and audio streams being provided to the client devices 102A-N, 104). For example, in response to being notified of the determined visual items for presentation in the UI 108A-N, the UI controller 136 can transmit a command causing each determined visual item to be displayed in a region of the UI and/or rearranged in the UI.

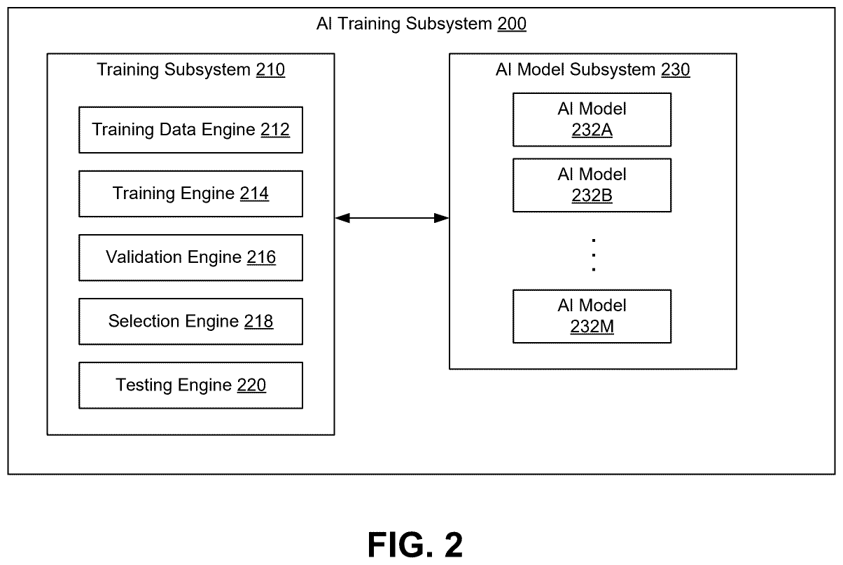

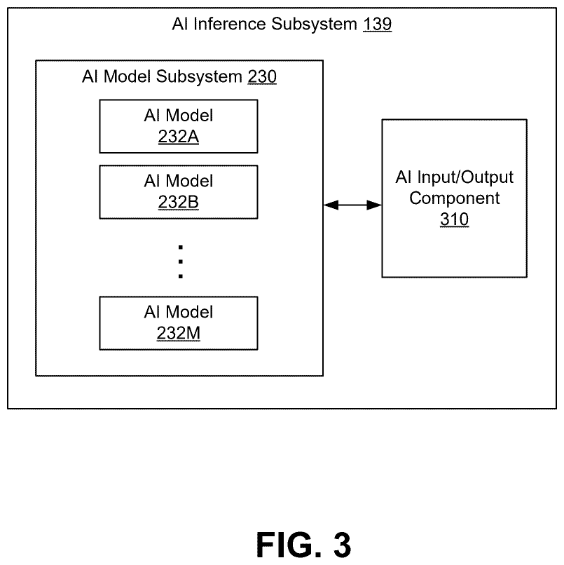

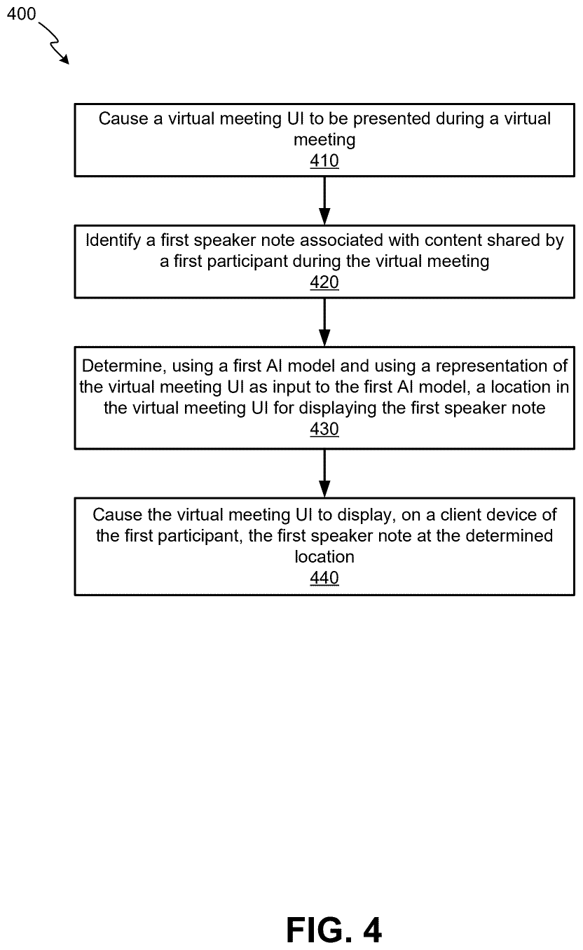

In one or more implementations, the virtual meeting manager 132 includes a speaker notes manager 138. The speaker notes manager 138 may include a software application (or a subset thereof) that performs certain virtual meeting functionality for the virtual meeting manager 132. The speaker notes manager 138 may be configured and/or otherwise programmed to determine a location in the virtual meeting UI 108A of the speaker participant's client device 102A for presenting speaker notes. The speaker notes manager 138 may be configured and/or otherwise programmed to automatically detect one or more conditions during the virtual meeting 122 and cause modification of the speaker notes to adjust to the conditions(s). The speaker notes manager 138 may include an AI inference subsystem 139. The AI inference subsystem 139 may include one or more AI models trained to determine the location in the virtual meeting UI 108A for presenting speaker notes or detect the occurrence of a predetermined condition during the virtual meeting 122. Some aspects of the speaker notes manager 138 are discussed further below in relation to FIG. 4. Some aspects of the AI inference subsystem 139 are discussed further below in relation to FIGS. 2-3. In some implementations, the speaker notes manager 138 includes a prompt subsystem (not shown) to generate prompts for the one or more AI models trained to determine the location in the virtual meeting UI 108A for presenting speaker notes or to detect the occurrence of a predetermined condition during the virtual meeting 122. Alternatively, the prompt subsystem is independent from the speaker notes manager 138 and communicates with the speaker notes manager 138 and/or its components via one or more APIs.

In some implementations, each of the virtual meeting platform 120 or the server 130 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting 122. The virtual meeting platform 120 can also include a website (e.g., one or more webpages) or application back-end software that can be used to enable a user to connect with other users by way of the virtual meeting 122.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component that can generate audio and video data to be streamed to the virtual meeting manager 132. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, the system architecture 100 includes a client device 104. The client device 104 can differ from a client device of the one or more client devices 102A-N because the client device 104 may be associated with a physical conference or meeting room. Such client device 104 can include or be coupled to a media system 110 that can include one or more display devices 112, one or more speakers 114 and one or more cameras 116. The display device 112 can be, for example, a smart display or a non-smart display (e.g., a display that is not itself configured to connect to the network 150). Users that are physically present in the room can use the media system 110 rather than their own devices (e.g., one or more of the client devices 102A-N) to participate in the virtual meeting 122, which can include other remote users. For example, the users in the room that participate in the virtual meeting 122 can control the display device 112 to show a slide presentation or watch slide presentations of other participants. Sound and/or camera control can similarly be performed. Similar to client devices 102A-N, the one or more client devices 104 can generate audio and video data to be streamed to the virtual meeting manager 132 (e.g., using one or more microphones, speakers 114 and cameras 116).

As described previously, an audiovisual component of each client device 102A-N, 104 can capture images and generate video data (e.g., a video stream) of the captured data of the captured images. In some implementations, the client devices 102A-N, 104 transmit the generated video stream to virtual meeting manager 132. The audiovisual component of each client device 102A-N, 104 can also capture an audio signal representing speech of a user and generate audio data (e.g., an audio file or audio stream) based on the captured audio signal. In some implementations, the client devices 102A-N, 104 transmit the generated audio data to the virtual meeting manager 132.

In some implementations, each client device 102A-N or 104 includes a respective client application 105A-N, which can be a mobile application, a desktop application, a web browser, etc. The client application 105A-N can present, on a display device 107-N of a client device 102A-N or a UI (e.g., a UI of the UIs 108A-N), one or more features of the client application 105A-N for users to access the virtual meeting platform 120. For example, a user of client device 102A can join and participate in the virtual meeting 122 via a UI 108A presented on the display device 107A by the client application 105A. The user can present a document to participants of the virtual meeting 122 using the UI 108A. Each of the UIs 108A-N can include multiple regions to present visual items corresponding to video streams of the client devices 102A-N provided to the server 130 for the virtual meeting 122.

In one or more implementations, the speaker notes manager 138 is part of a client device 102A-N, 104. For example, the client application 105A can include the speaker notes manager 138, which can determine a location in the UI 108A for speaker notes or can modify the speaker notes to adjust to the occurrence of a predetermined condition during the virtual meeting 122. In some implementations, the client application 105A sends the video stream to the other client devices 102B-N, 104, and receives the video streams from the other client devices 102B-N, 104, and the client applications 105A-N can generate their respective virtual meeting UIs 108A-N or can finalize their respective UIs 108A-N, which may have been partially generated by the UI controller 136.

In some implementations, the data store 140 is a persistent storage that is capable of storing data as well as data structures to tag, organize, and index the data. A data item can include audio data and/or video stream data, in accordance with implementations described herein. The data store 140 can be hosted by one or more storage devices, such as main memory, magnetic or optical storage-based disks, tapes, hard drives, flash memory, and so forth. In some implementations, the data store 140 is a network-attached file server, while in other implementations, the data store 140 is some other type of persistent storage such as an object-oriented database, a relational database, and so forth, that can be hosted by the virtual meeting platform 120 or one or more different machines (e.g., the server 130) coupled to the virtual meeting platform 120 using the network 150. In some implementations, the data store 140 stores portions of audio and video streams received from one or more client devices 102A-N, 104 for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-N, 104 and/or concurrently editable by the users.

In some implementations, the network 150 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the virtual meeting platform 120 or the server 130 are provided by a fewer number of machines. For example, in some implementations, the server 130 is integrated into a single machine, while in other implementations, the server 130 is integrated into multiple machines. In addition, in one or more implementations, the server 130 is integrated into the virtual meeting platform 120.

In general, one or more functions described in the several implementations as being performed by the virtual meeting platform 120 or server 130 can also be performed by the client devices 102A-N, 104 in other implementations, if appropriate. In addition, in some implementations, the functionality attributed to a particular component can be performed by different or multiple components operating together. The virtual meeting platform 120 or the server 130 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 illustrates an example AI training subsystem 200 that can be used to train the AI model 230A-M, in accordance with implementations of the present disclosure. As illustrated in FIG. 2, the AI training subsystem 200 can include a training subsystem 210, which may include a training data engine 212, a training engine 214, a validation engine 216, a selection engine 218, or a testing engine 220. The AI training subsystem 200 may include an AI model subsystem 230, which may include one or more AI models 232A-M.

In one implementation, an AI model 232A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron may be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, an AI model 232A-M includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), a large language model (LLM), or a diffusion model. In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, an AI model 232A-M is an AI model that has been trained on a corpus of data. For example, the AI model 232A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 232A-M to learn broad elements including, image or speech recognition, general sentence structure, common phrases, vocabulary, natural language structure, and other elements. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 232A-M while training may be ranked by a user, according to a variety of factors, including accuracy, helpfulness, veracity, acceptability, or any other metric useful in the fine-tuning portion of training. In this manner, the AI model 232A-M can learn to favor these and any other factors relevant to users when generating a response. Further details regarding training are provided below.

In some implementations, an AI model 232A-M includes one or more pre-trained models, or fine-tuned models. In a non-limiting example, in some implementations, the goal of the “fine-tuning” can be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

As indicated above, an AI model 232A-M may be one or more generative AI models, allowing for the generation of new and original content. In one implementation, a generative AI model includes a diffusion model. A diffusion model may include a deep generative model that can be used to generate images, edit existing images, and create new image styles. The diffusion model may have been trained by iteratively applying a diffusion process to an input image, which may include gradually adding noise to the image until it becomes unrecognizable. The diffusion model then learns to reverse this process, starting from the noisy image and gradually denoising it until it becomes a recognizable image. In some implementations, the diffusion model may have been trained on multiple virtual meeting backgrounds by using different virtual meeting backgrounds as input images during the training process.

In one implementation, the training subsystem 210 manages the training and testing of an AI model 232A-M. The training data engine 212 can generate training data (e.g., a set of training inputs such as noisy virtual meeting background images and a set of target outputs such as respective denoised virtual meeting background images) to train an AI model 232A-M. In an illustrative example, the training data engine 212 can initialize a training set T to null (e.g., {}). The training data engine 212 can add the training data to the training set T and can determine whether training set T is sufficient for training a AI model 232A-M. The training set T can be sufficient for training the AI model 232A-M if the training set T includes a threshold amount of training data, in some implementations. In response to determining that the training set T is not sufficient for training, the training data engine 212 can identify additional data to use as training data. In response to determining that the training set T is sufficient for training, the training data engine 212 can provide the training set T to the training engine 214.

In some implementations, the training data includes one or more images of a virtual meeting UI (e.g., a virtual meeting UI similar to the UI 108A-N). For each image of a virtual meeting UI, the training data may include one or more target outputs that indicate a location in the respective virtual meeting UI where one or more speaker notes can be presented.

The training engine 214 can train an AI model 232A-M using the training data (e.g., training set T). The AI model 232A-M may refer to the model artifact that is created by the training engine 214 using the training data, where such training data can include training inputs and, in some implementations, corresponding target outputs. The training engine 214 can input the training data into the AI model 232A-M so that the AI model 232A-M can find patterns in the training data and configure itself based on those patterns.

Where the AI model 232A-M uses supervised learning, the training engine 214 can assist the AI model 232A-M in determining whether the AI model 232A-M maps the training input to the target output. Where the AI model 232A-M uses unsupervised learning, the training engine 214 can input the training data into the AI model 232A-M The AI model 232A-M can configure itself based on the input training data, but since the training data may not include a target output, the training engine 214 may not assist the AI model 232A-M in determining whether the AI model 232A-M provided a correct output during the training process.

The validation engine 216 may be capable of validating a trained AI model 232A-M using a corresponding set of features of a validation set from the training data engine 212. The validation engine 216 can determine an accuracy of each of the trained AI models 232A-M based on the corresponding sets of features of the validation set. Where the training data may not include a target output, validating a trained AI model 232A-M may include obtaining an output from the AI model 232A-M and providing the output to another entity for evaluation. The other entity may include another AI model trained to evaluation the output of the AI model 232A-M that is undergoing training. The other entity may include a human. The validation engine 216 can discard a trained AI model 232A-M that has an accuracy that does not meet a threshold accuracy or that otherwise fails evaluation. In some implementations, the selection engine 218 is capable of selecting a trained AI model 232A-M that has an accuracy that meets a threshold accuracy. In some implementations, the selection engine 218 may be capable of selecting the trained AI model 232A-M that has the highest accuracy of multiple trained AI models 232A-M. In some implementations, the selection engine 218 receives input from another AI model or a human and can select a trained AI model 232A-M based on the input.

The testing engine 220 may be capable of testing a trained AI model 232A-M using a corresponding set of features of a testing set from the training data engine 212. For example, a first trained AI model 232A that was trained using a first set of features of the training set may be tested using the first set of features of the testing set. The testing engine 220 can determine a trained AI model 232A-M that has the highest accuracy or other evaluation of all of the trained AI models 232A-M based on the testing sets.

In one implementation, the training engine 214 trains an AI model 232A. The training data engine 212 can generate training data that includes images of virtual meeting backgrounds, and the training engine 214 can cause the AI model 232A to undergo a diffusion model training process using the training data. The AI model 232A can undergo a validation and testing process using the validation engine 216 and testing engine 220.

In some implementations, the AI training subsystem 200 is part of the server 130, the virtual meeting manager 132, or the speaker notes manager 138. Alternatively, the AI training subsystem 200 may be part of another server, system, sub-system, or it may be an independent system. In some implementations, the AI training subsystem 200 provides the trained one or more AI models 232A-M to the speaker notes manager 138.

As indicated above, in some embodiments, the AI model 232A-M can include an LLM. In some embodiments, the LLM can include generative AI functionality. In such embodiments, the AI model 232A-M can generate new content based on provided input data.

FIG. 3 illustrates an example AI inference subsystem 139 that the speaker notes manager 138 may use to perform one or more operations, in accordance with implementations of the present disclosure. The AI inference subsystem 139 may include an AI model subsystem 230, which may include one or more AI models 232A-M. The one or more AI models 232A-M may include one or more of the AI models 232A-M trained by the AI training subsystem 300.

In some implementations, the AI inference subsystem 139 includes an AI input/output component 310. The AI input/output component 310 can be configured and/or otherwise programmed to feed data as input to an AI model 232A-M, e.g., a representation of the virtual meeting UI 108A-N or a portion of the transcript of the virtual meeting 122 from the speaker notes manager 138. The AI input/output component 310 can be configured and/or otherwise programmed to obtain one or more outputs from the one or more AI models 232A-M and provide the one or more outputs to the speaker notes manager 138, as discussed below regarding FIG. 4.

In some implementations, AI model 232A-M is a generative AI model that receives input from a prompt subsystem (not shown). The prompt subsystem can perform automated identification of, and facilitate retrieval of, relevant and timely contextual information for efficient and accurate processing of prompts by the AI model 232A-M. Using the network 150 (or another network), the prompt subsystem can be in communication with one or more of the virtual meeting manager 132, the speaker notes manager 138, the AI inference subsystem 139, or the data store 140. Communications between the prompt subsystem and the AI inference subsystem 139 may be facilitated by a generative model application programming interface (API), in some embodiments. Communications between the prompt subsystem and the virtual meeting manager 132, the speaker notes manager 138, the AI inference subsystem 139, or the data store 140 may be facilitated by a data management API. In additional or alternative embodiments, the generative model API can translate prompts generated by the prompt subsystem into unstructured natural-language format and, conversely, translate responses received from the AI model 232A-M into any suitable form (e.g., including any structured proprietary format as may be used by the prompt subsystem). Similarly, the data management API can support instructions that may be used to communicate data requests to the virtual meeting manager 132, the speaker notes manager 138, the AI inference subsystem 139, or the data store 140 and formats of data received from such components.

As indicated above, a user can interact with the prompt subsystem via a prompt interface. The prompt interface may appear on a UI 108A-N of a client device 102A-N, 104. The prompt interface may include a UI element that can support any suitable types of user inputs (e.g., textual inputs, speech inputs, image inputs, etc.). The UI element may further support any suitable types of outputs (e.g., textual outputs, speech outputs, image outputs, etc.). In some embodiments, the UI element can be a web-based UI element, a mobile application-supported UI element, or any combination thereof. The UI element can include selectable items, in some embodiments, that enable a user to select from multiple generative AI models 232A-M. The UI element can allow the user to provide consent for the prompt subsystem or the generative AI model 232A-M to access user data or other data associated with a client device 102A-N, 104 stored in the data store 140, process, or store new data received from the user, and the like. The UI element can additionally or alternatively allow the user to withhold consent to provide access to user data. In some embodiments, user input entered using the UI element may be communicated to the prompt subsystem by a user API. The user API can be located at the client device 102A-N, 104 of the user accessing the query tool.

In some embodiments, the prompt subsystem can include a prompt analyzer to support various operations of this disclosure. For example, the prompt analyzer may receive an input (e.g., a prompt submitted by a user of or component of the system 100) and generate one or more intermediate prompts to the generative AI model 232A-M to determine what type of data the generative AI model may need to successfully respond to the input. Upon receiving a response from the generative AI model 232A-M, the prompt analyzer may analyze the response, form a request for relevant contextual data for the data store 140, which may then supply such data. The prompt analyzer may then generate a prompt to the generative AI model 232A-M that includes the original prompt and the contextual data. In some embodiments, the prompt analyzer may, itself, include a lightweight generative AI model that may process the intermediate prompt(s) and determine what type of contextual data may be needed by the generative AI model 232A-M together with the original prompt to ensure a meaningful response from generative AI model 232A-M.

The prompt subsystem may include (or may have access to) instructions stored on one or more tangible, machine-readable storage media of a computing device (e.g., the server 130) and executable by one or more processing devices of the computing device. In one embodiment, the prompt subsystem may be implemented on a single machine. In some embodiments, the prompt subsystem may be a combination of a client component and a server component. In some embodiments the prompt subsystem may be executed entirely on a client device 102A-N, 104. Alternatively, some portion of the prompt subsystem may be executed on a client computing device while another portion of the query tool may be executed on a server machine.

FIG. 4 is a flowchart illustrating one embodiment of a method 400 for environment- and audio-aware speaker notes for a virtual meeting, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 400 and/or one or more of the method's 400 individual functions, routines, subroutines, or operations. In certain implementations, a single processing thread can perform the method 400. Alternatively, two or more processing threads can perform the method 400, each thread executing one or more individual functions, routines, subroutines, or operations of the method. In an illustrative example, the processing threads implementing the method 400 can be synchronized (e.g., using semaphores, critical sections, and/or other thread synchronization mechanisms). Alternatively, the processing threads implementing the method 400 can be executed asynchronously with respect to each other. Various operations of the method 400 can be performed in a different (e.g., reversed) order compared with the order shown in FIG. 4. Some operations of the method 400 can be performed concurrently with other operations. Some operations can be optional. In some implementations, the speaker notes manager 138 performs one or more of the operations of the method 400.

At block 410, processing logic causes a virtual meeting UI 108A to be presented during a virtual meeting 122 between one or more participants. The virtual meeting UI 108A may include one or more first regions. Each first region can correspond to a participant of the one or more participants.

In some implementations, the virtual meeting UI 108A is presented on the display device 107A of a first client device 102A. The first client device 102A can be used by a first participant of the virtual meeting 122. The first participant may include a speaker participant. As discussed above, a speaker participant may include a participant of the virtual meeting that performs a significant portion of the speaking during the virtual meeting 122 and that prepares speaker notes for use during the virtual meeting 122.

At block 420, processing logic identifies a first speaker note. The first speaker note can be associated with content shared by the first participant during the virtual meeting 122.

In one implementation, a speaker note includes data that is presentable on a UI so that a speaker participant of a virtual meeting 122 can view the speaker note. The speaker note can remind the speaker participant of things to say or discussion points to cover during the virtual meeting 122. The speaker note may include text data, image data, or other data that can be presented on a UI. For example, a speaker note may include a bullet point with text data, and multiple speaker notes can form a bullet point list with each point including text data, and different bullet points of the list may include different levels of indentation. In another example, a speaker note may include one or more sentences of text data without bullet point formatting.

In some implementations, a speaker note can be associated with content shared by the speaker participant during the virtual meeting 122. The content may include a slide presentation, a text document, a spreadsheet, an image, a video, or other suitable electronic content. The content may include a file stored on the first client device 102A used by the speaker participant. The content may include a file stored in the data store 140 or on a cloud storage platform. In one or more implementations, different speaker notes can be associated with different portions of the content. For example, where the content is a slide presentation, a first speaker note can be associated with a first slide, and a second speaker note can be associated with a second slide. In another example, where the content is a video, a first speaker note can be associated with a first portion of the video, and a second speaker note can be associated with a second, subsequent portion of the video.

In one implementation, the speaker note being associated with the content includes the content including the speaker note. For example, where the content includes a slide presentation file, the speaker note may include data included in the file. In some implementations, the speaker note being associated with the content includes the speaker note being stored in a file separate from the content, but the speaker note file can be logically linked to the content.

In one or more implementations, identifying the first speaker note may include the speaker notes manager 138 obtaining the first speaker note. The speaker notes manager 138 can obtain the first speaker note from the first client device 102A, the data store 140, a cloud storage platform, or another location. For example, where the content includes a file stored on the first client device 102A, the client application 105A can obtain the content (including the associated first speaker note) from the client device 102A storage and provide the associated first speaker note using a file upload or a data upload. In another example, where the content includes content stored on the data store 140 or a cloud storage platform, the speaker participant can use the virtual meeting UI 108A to select the content, and the data store 140 or the cloud storage platform can provide the content using an API or other protocol to transfer the content or the associated first speaker note to the virtual meeting manager 132, which can provide the first speaker note to the speaker notes manager 138.

At block 430, processing logic determines a location in the virtual meeting UI 108A for displaying the first speaker note. Determining the location may include using a first AI model 232A and using a representation of the virtual meeting UI 108A as input to the first AI model 232A.

In one implementation, the representation of the virtual meeting UI 108A includes an image of the virtual meeting UI 108A. The client application 105A can capture the image of the virtual meeting UI 108A and send the image to the speaker notes manager 138. The representation of the virtual meeting UI 108A may include data in another format that indicates the locations, sizes, and other features of the components of the virtual meeting UI 108A. The components of the virtual meeting UI 108A may include the regions corresponding to video streams of the one or more participants of the virtual meeting 122, a region corresponding to shared content, toolbars or side panels of the UI 108A (discussed below), or other components of the UI 108A.

The speaker notes manager 138 can provide the representation of the virtual meeting UI 108A to the AI inference subsystem 139. The AI input/output component 310 of the AI inference subsystem 139 can provide the representation of the virtual meeting UI 108A to the first AI model 232A as input. As discussed above in relation to FIGS. 2-3, the first AI model 232A may have been trained to determine placement of speaker notes on virtual meeting UIs. The first AI model 232A can process the input representation of the virtual meeting UI 108A and generate an output indicating a location on the virtual meeting UI 108A for displaying the first speaker note. The first AI model 232A can provide the output to the AI input/output component 310, which can provide the output to the speaker notes manager 138. In one implementation, the first AI model 232A may include a computer vision model configured and/or otherwise programmed to recognize locations in images for presentation of speaker notes.

The location determined by the first AI model 232A may include a location in the virtual meeting UI 108A that is in the line of sight of the speaker participant such that the speaker participant does not break eye contact with the camera of the speaker participant's client device 102A. Eye contact with the camera, in some implementations, includes more than direct eye contact and may include the speaker participant's eyes looking within a threshold distance from the camera. The location may include a location in the virtual meeting UI 108A that would not result in the speaker note covering a predetermined portion of the virtual meeting UI 108A. A predetermined portion of the virtual meeting UI 108A may include a portion of the virtual meeting UI 108A that includes text or an image.

At block 240, processing logic causes the virtual meeting UI 108A to display, on a client device 102A of the first participant, the first speaker note at the determined location in the virtual meeting UI 108A. Processing logic may not cause the virtual meeting UIs 108B-N of the client devices 102B-N associated with participants other than the first participant (e.g., the speaker participant) to display the first speaker note. Thus, in some implementations, the first speaker note is only displayed on the virtual meeting UI 108A of the client device 102A of the speaker participant.

In one implementation, the determined location includes a first region of the one or more first regions. As discussed above, the virtual meeting UI 108A-N may include one or more first regions, and each first region can correspond to a video stream of a respective participant of the one or more participants of the virtual meeting 122. Each first region can present a visual item corresponding to the respective video stream. The video stream may include a depiction of at least a portion of the respective participant (e.g., the participant's head, torso, body, or the like). The determined location may include a location in the video stream that allows the speaker participant to view the participant depicted in the video stream (e.g., a location above the head of the participant, the torso of the participant, or some other location).

In some implementations, the virtual meeting UI 108A-N includes a second region. The second region can correspond to a presentation of content by the speaker participant. For example, the second region can correspond to a slide presentation and can present the slide presentation on the virtual meeting UI 108A-N. The determined location may include a location in the second region. The location in the second region may include a location that does not include images or words. For example, where the second region presents a slide of a slide presentation, the determined location may include a portion of the slide that does not include text or images that are included in the slide.

In some implementations, the first speaker note is associated with a predetermined portion of the content. The speaker notes manager 138 may cause the virtual meeting UI 108A to display the first speaker notes in response to the presentation of content displaying the predetermined portion of the content. The content may include a slide presentation, and the predetermined portion of the content may include a predetermined slide of the slide presentation. one implementation, the content may include a video, and the predetermined portion of the content may include a predetermined portion of the video.

In some implementations, the virtual meeting manager 132 identifies which portion of the content is currently being displayed. For example, the virtual meeting manager 132 can obtain data from the client application 105A indicating which portion of the content is currently being displayed. The virtual meeting manager 132 can provide data to the speaker notes manager 138 indicating which portion of the content is currently being displayed.

As an example, the virtual meeting UI 108A-N may include a second region that corresponds to the presentation of content, and the content may include a slide presentation that includes multiple slides. The first speaker note can be associated with the third slide of the slide presentation. The virtual meeting manager 132 may provide data to the speaker notes manager 132 indicating which slide of the multiple slides is currently being displayed in the second region. Responsive to the virtual meeting UI 108A-N displaying the first and second slides of the slide presentation in the second region, the speaker notes manager 138 may not cause the virtual meeting UI 108A to display the first speaker note. Responsive to the virtual meeting UI 108A-N displaying the third slide, the speaker notes manager 138 can cause the virtual meeting UI 108A to display the first speaker note at the determined location.

In one or more implementations, the determined location may include a location of the virtual meeting UI 108A that is external to a first region or a second region of the virtual meeting UI 108A. For example, the virtual meeting UI 108A-N may include a margin or buffer space between different regions or above or below the regions, and the determined location may be in one of these margins or buffer spaces.

In some implementations, the speaker notes manager 138 can cause the first speaker note to be displayed in the determined location and be presented in a font, size, or color that is legible in the determined location. The color may include a color that contrasts with the color of the determined location. For example, where the determined location is a black-colored buffer space between multiple regions of the virtual meeting UI 108A-N, the speaker notes manager 138 can cause the first speaker note to be displayed in a white color.

In one implementation, the speaker notes manager 138 can obtain at least a portion of a transcript of the virtual meeting 122. The virtual meeting manager 132 can generate the transcript of the virtual meeting 122. The transcript of the virtual meeting 122 may include a text representation of dialogue spoken by the one or more participants of the virtual meeting 122. The virtual meeting manager 132 can use a speech-to-text AI model to generate the transcript. The speech-to-text AI model can use, as input, one or more portions of one or more audio streams produced by the one or more client devices 102A-N of the one or more participants of the virtual meeting 122. The virtual meeting manager 132 can obtain portions of the audio streams in real time (e.g., the virtual meeting manager 132 can obtain the portions of the audio stream as they arrive at the server 130). The virtual meeting manager 132 can generate the portions of the transcript in real time. The virtual meeting manager 132 can provide the portions of the transcript to the speaker notes manager 138 in real time. Real-time refers to the ability for the virtual meeting manager 132 to obtain the portions of the audio stream, generate the portions of the transcript, and/or provide the portions of the transcript instantly without transmission delays and/or with negligible (e.g., milliseconds or microseconds) latency.

As discussed above, the first speaker note can be associated with a predetermined portion of content. The speaker participant can move on to a second portion of content that is not associated with the first speaker note. The speaker participant may not have covered the first speaker note (e.g., the speaker participant may not have discussed material related to the first speaker note, for example, because the speaker participant forgot to do so). It may be helpful to remind the speaker participant of the first speaker note that was not covered.

In one implementation, the speaker notes manager 138 can determine that the virtual meeting UI 108A of the client device 102A of the speaker participant is presenting a second portion of the content (e.g., a second slide of a slide presentation). The second portion of the content may be subsequent to the first portion, and the first portion may be associated with the first speaker note. The speaker notes manager 138 can determine that the speaker participant has not discussed the first speaker note. For example, the speaker notes manager 138 can use an AI model 232B and can use at least a portion of a transcript of the virtual meeting 122 as input to the AI model 232B. The AI model 232B may include a generative AI model, and the speaker notes manager 138 can generate a generative AI prompt. The prompt may include a portion of the transcript, the first speaker note, and a command to determine whether the portion of the transcript covers the first speaker note. Responsive to the AI model 232B indicating that the portion of the transcript does not cover the first speaker note, the speaker notes manager 138 can cause the virtual meeting UI 108A to display the first speaker note. Displaying the first speaker note may include displaying the first speaker note using different visual indications than other speaker notes (e.g., a different font, size, etc.) in order to remind the speaker participant of the first speaker note that the speaker participant did not discuss.

In some implementations, causing the virtual meeting UI 108A to display the first speaker note at the determined location in the virtual meeting UI 108A is responsive to determining that the first participant spoke a predetermined phrase. Determining that the first participant spoke the predetermined phrase may include using a second AI model 232C and using the at least a portion of the transcript as input to the second AI model 232C.

In one implementation, the first speaker note may include metadata or other data associated with the first speaker note. The metadata may be stored with the data storing the first speaker note or may be logically linked to the data storing the first speaker note. The metadata may include the predetermined phrase. The speaker notes manager 138 can obtain the metadata as part of obtaining the first speaker note.

In one implementation, the speaker notes manager 138 causes the virtual meeting UI 108A to modify the first speaker note responsive to determining, using an AI model 232D and using the at least a portion of the transcript as input to the AI model 232D, that the first participant has discussed the first speaker note. In some implementations, the AI model 232D includes a generative AI model. The speaker notes manager 138 can generate a generative AI prompt that can be input into the AI model 232D. The generative AI prompt may include the portion of the transcript, the first speaker note, and a command for the AI model 232D to determine whether the portion of the transcript discussed the first speaker note. The speaker notes manager 138 can provide the generative AI prompt to the AI model 232D, and the AI model 232D can generate an output indicating whether the portion of the transcript discussed the first speaker note.

Responsive to the output indicating that the portion of the transcript discussed the first speaker note, the speaker notes manager 138 can cause the virtual meeting UI 108A of the client device 102A of the speaker participant to modify the presentation of the first speaker note on the virtual meeting UI 108A. Modifying the presentation of the first speaker note may include presenting the text of the first speaker note with a strikethrough, in a different color, or using some other visual indication to indicate to the speaker participant that the first speaker note has been discussed.

Responsive to the output indicating that the portion of the transcript discusses the first speaker note, the speaker notes manager 138 can cause the virtual meeting UI 108A of the client device 102A of the speaker participant to display one or more second speaker notes. The one or more second speaker notes may include subsequent speaker notes, sub-bullet points of the first speaker note, or other types of speaker notes.

In one implementation, the one or more participants include a second participant. During the virtual meeting 122, the second participant can ask a question. The speaker participant may plan on discussing material associated with the first speaker note later in the virtual meeting 122, and the discussed material can answer the second participant's question. Thus, it may be beneficial to indicate the second participant's question responsive to displaying the first speaker note to the speaker participant. In one implementation, the speaker notes manager 138 obtains at least a portion of a transcript of the virtual meeting 122. The portion of the transcript may include the question asked by the second participant. The speaker notes manager 138 can identify the question asked by the second participant. The speaker notes manager 138 can use an AI model 232E and can use the portion of the transcript as input to the AI model 232E. The AI model 232E may include a generative AI model. The speaker notes manager 138 can generate a generative AI prompt that includes the portion of the transcript and a command to identify a question in the portion of the transcript. The AI model 232E can process the input and can output the question in the portion of the transcript.

The speaker notes manager 138 can determine that the first speaker note answers the question asked by the second participant. The speaker notes manager 138 can use an AI model 232F and can use the question asked by the second participant and the first speaker note as input to the AI model 232F. The AI model 232F may include a generative AI model, and the speaker notes manager 138 can generate a generative AI prompt. The prompt may include the identified question asked by the second participant, the first speaker note, and a command to determine if the first speaker note answers the identified question. Responsive to the AI model 232F indicating that the first speaker note answers the question, the speaker notes manager 138 can cause the virtual meeting UI 108A to display the question asked by the second participant at the determined location in the virtual meeting UI 108A. For example, the virtual meeting UI 108A can display the question above the first speaker note or to a side of the first speaker note so the speaker participant can be reminded that the second participant asked the question. If the first speaker note is associated with a different portion of content than the content displayed when the second speaker asked the question, the virtual meeting UI 108A may not immediately display the question and can display the question responsive to the virtual meeting UI 108A displaying the different portion of the content and the first speaker note.

While the present disclosure discusses different AI models 232A-F above in relation to the method 400, in some implementations, one or more of the AI models 232A-F are the same AI model. For example, one or more of the AI models 232A-F may be a general purpose LLM, as discussed above, configured and/or otherwise programmed to generate answers to prompts. The LLM may have been trained on a variety of inputs and may be able to generate outputs to the wide variety of inputs.

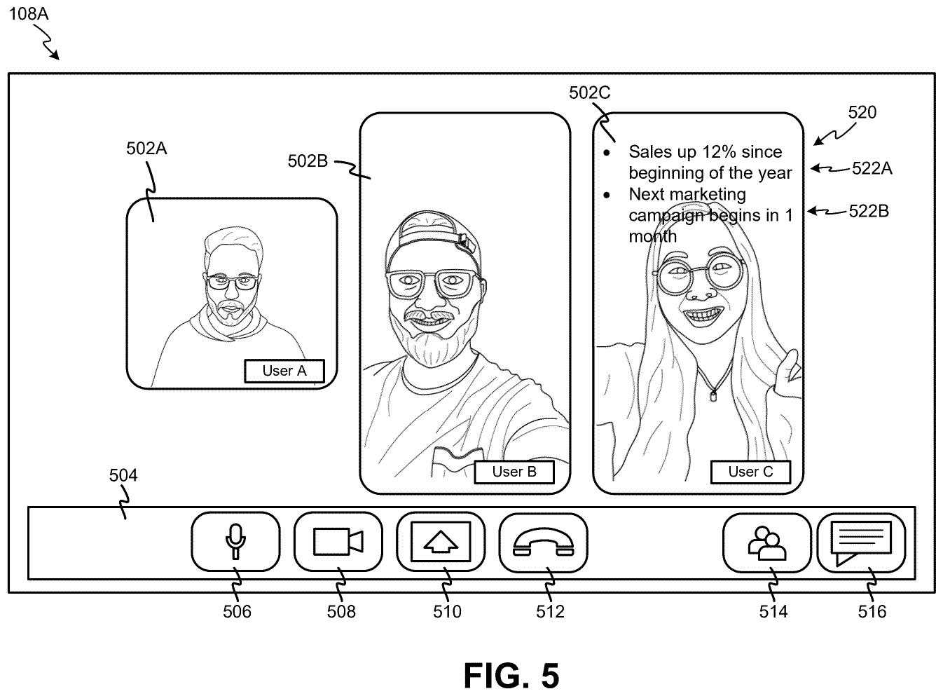

FIG. 5 depicts an example virtual meeting UI 108A, in accordance with some implementations of the present disclosure. The virtual meeting UI 108A may include a virtual meeting UI 108A presented on a client device 102A of a speaker participant of a virtual meeting 122.

The virtual meeting UI 108A may include one or more regions 502A-C corresponding to a visual item of the virtual meeting 122, such as a video stream provided by a client device 102A-N, 104 of a participant of the virtual meeting 122. The virtual meeting UI 108A can include a toolbar 504 that includes one or more UI elements configured and/or otherwise programmed to perform virtual meeting operations. For example, as seen in FIG. 5, the toolbar 504 includes an audio control button 506 used to mute and unmute a participant's audio stream, a camera control button 508 used to mute and unmute a participant's video stream, a screen share button 510 used to share a participant's client device's 102A-N, 104 screen with other participants of the virtual meeting 122, and a disconnect button 512 used to leave or disconnect from the virtual meeting 122. The toolbar 504 may include a participants button 514 that can display a list of the one or more participants of the virtual meeting 122. The toolbar 504 may include a chat button 516 that can display a chat interface that allows participants of the virtual meeting 122 to send and receive chat messages in the virtual meeting 122.

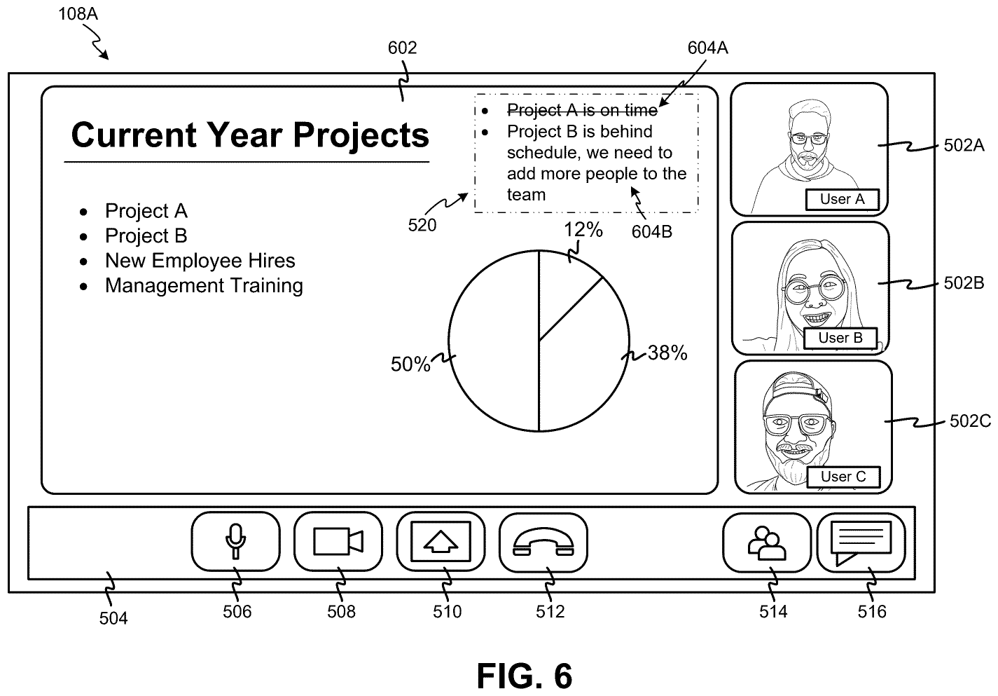

In some implementations, the virtual meeting UI 108A includes one or more speaker notes 520. The location of the one or more speaker notes 520 may include the location determined by the speaker notes manager 138 in block 430 of the method 400. For example, as seen in FIG. 5, the one or more speaker notes 520 can be presented on the first region 502C that corresponds to a video stream of a third participant of the virtual meeting 122. The example determined location in FIG. 6 includes a location above the head of the participant depicted in the first region 502C, so the face of the participant is not blocked by the one or more speaker notes 520. The one or more speaker notes 520 may include a first speaker note 522A and a second speaker note 522B. The one or more speaker notes 520 may be text organized into bullet points, as seen in FIG. 5.

FIG. 6 depicts another example virtual meeting UI 108A, in accordance with some implementations of the present disclosure. The virtual meeting UI 108A may include one or more components of the virtual meeting UI 108A of FIG. 5 (e.g., the one or more first regions 502A-C and the toolbar 504 with its respective components 506-516).

In one implementation, the virtual meeting UI 108A may include a second region 602. As discussed above, the second region 602 can correspond to a visual item of the virtual meeting 122, such as a presentation of content by the speaker participant. For example, as seen in FIG. 6, the second region 602 presents a slide presentation of the speaker participant. The virtual meeting UI 108A can present the one or more speaker notes 520 in the second region 602. As seen in FIG. 6, the determined location in the second region 602 where the one or more speaker notes 520 are presented includes a portion of the currently displayed slide of the slide presentation that does not include any text or images.

As also seen in the example virtual meeting UI 108A of FIG. 6, the first speaker note 604A is presented with strikethrough. The speaker notes manager 138 may have caused the virtual meeting UI 108A to modify the first speaker note 604A with strikethrough responsive to determining that the speaker participant has covered the first speaker note 604A. The strikethrough may indicate to the speaker participant that the speaker participant has already covered the first speaker note 604A. The second speaker note 604B may not be presented with strikethrough, indicating that the speaker participant has not yet covered the second speaker note 604B.

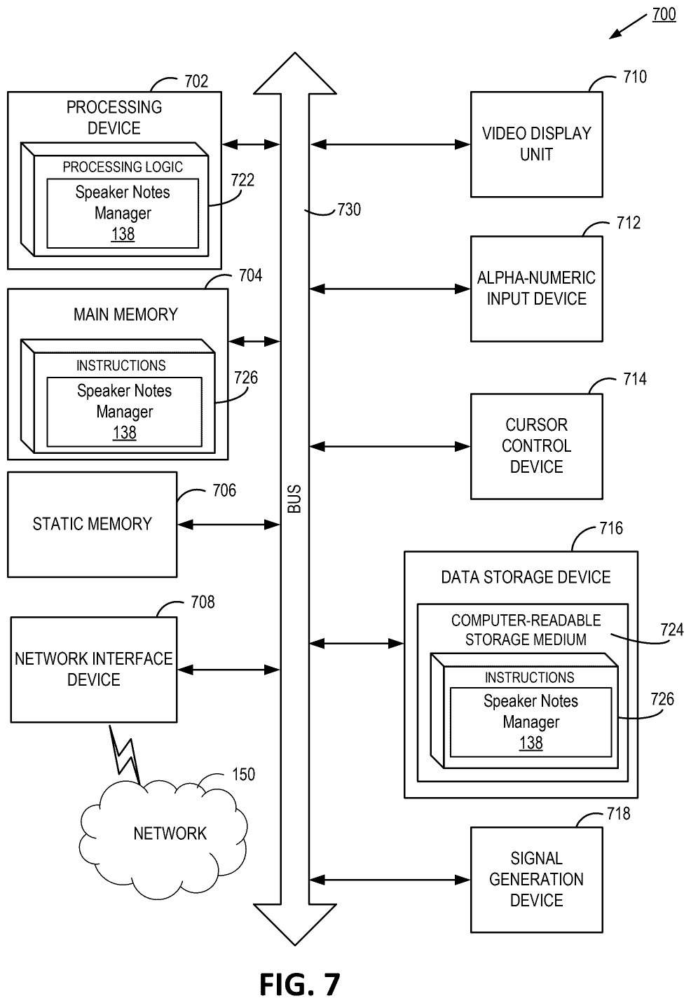

FIG. 7 is a block diagram illustrating an example computer system, in accordance with implementations of the present disclosure. The computer system 700 can include a client device 102A-N, 104, the virtual meeting platform 120, or the server 130 in FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 716, which communicate with each other via a bus 730.

The processing device 702 represents one or more general-purpose processing devices such as a microprocessor, central processing unit, or the like. More particularly, the processing device 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 can also be one or more special-purpose processing devices such as an application specific integrated circuit (ASIC), a field programmable gate array (FPGA), a digital signal processor (DSP), network processor, or the like. The processing device 702 is configured to execute the processing logic 722 for performing the operations discussed herein (e.g., the operations of the speaker notes manager 138).

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (sometimes referred to as a “computer-readable storage medium”) on which is stored one or more sets of instructions 726 (e.g., the instructions to carry out one or more operations of the speaker notes manager 138) embodying any one or more of the methodologies or functions described herein. The instructions can also reside, completely or at least partially, within the main memory 704 and/or within the processing device 702 during execution thereof by the computer system 700, the main memory 704 and the processing device 702 also constituting machine-readable storage media. The instructions can further be transmitted or received over the network 150 via the network interface device 708.

In one implementation, the instructions 726 include instructions for determining visual items for presentation in a user interface of a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method, comprising:
causing a virtual meeting user interface (UI) to be presented during a virtual meeting between a plurality of participants, the virtual meeting UI comprising a plurality of first regions each corresponding to a participant of the plurality of participants;
identifying a first speaker note associated with content shared by a first participant of the plurality of participants during the virtual meeting;
determining, using a first artificial intelligence (AI) model and using a representation of the virtual meeting UI as input to the first AI model, a location in the virtual meeting UI for displaying the first speaker note; and
causing the virtual meeting UI to display, on a client device of the first participant, the first speaker note at the determined location in the virtual meeting UI.

2. The method of claim 1, wherein the determined location comprises a region of the plurality of first regions.

3. The method of claim 1, wherein:
the virtual meeting UI further comprises a second region corresponding to a presentation of content by the first participant of the plurality of participants; and
the determined location comprises the second region.

4. The method of claim 1, wherein:
the virtual meeting UI further comprises a second region corresponding to a presentation of content by the first participant of the plurality of participants; and
causing the virtual meeting UI to display the first speaker note at the determined location is responsive to the presentation of content displaying a predetermined portion of the content.

5. The method of claim 4, wherein:
the content comprises a slide presentation; and
the predetermined portion of the content comprises a first slide of the slide presentation.

6. The method of claim 5, further comprising:
determining that the virtual meeting UI is presenting a second slide of the slide presentation, wherein the second slide is subsequent to the first slide;
determining, using a second AI model and using at least a portion of a transcript of the virtual meeting as input to the second AI model, that the first participant has not discussed the first speaker note; and
causing the virtual meeting UI to display the first speaker note.

7. The method of claim 1, wherein the method further comprises obtaining at least a portion of a transcript of the virtual meeting.

8. The method of claim 7, wherein causing the virtual meeting UI to display the first speaker note at the determined location in the virtual meeting UI is responsive to determining, using a second AI model and using the at least a portion of the transcript as input to the second AI model, that the first participant spoke a predetermined phrase.

9. The method of claim 7, further comprising causing the virtual meeting UI to modify the first speaker note responsive to determining, using a second AI model and using the at least a portion of the transcript as input to the second AI model, that the first participant has discussed the first speaker note.

10. The method of claim 7, further comprising causing the virtual meeting UI to display one or more second speaker notes responsive to determining, using a second AI model and using the at least a portion of the transcript as input to the second AI model, that the first participant has discussed the first speaker note.

11. A system, comprising:
a memory; and
a processing device, coupled to the memory, configured to perform operations comprising:
causing a virtual meeting user interface (UI) to be presented during a virtual meeting between a plurality of participants, the virtual meeting UI comprising a plurality of first regions each corresponding to a participant of the plurality of participants,
identifying a first speaker note associated with content shared by a first participant of the plurality of participants during the virtual meeting,
determining, using a first artificial intelligence (AI) model and using a representation of the virtual meeting UI as input to the first AI model, a location in the virtual meeting UI for displaying the first speaker note, and
causing the virtual meeting UI to display, on a client device of the first participant, the first speaker note at the determined location in the virtual meeting UI.

12. The system of claim 11, wherein:
the plurality of participants further comprises a second participant;
the operations further comprise:
obtaining at least a portion of a transcript of the virtual meeting, wherein the at least a portion of the transcript includes dialogue spoken by the second participant, and
identifying, using a second AI model and using the at least a portion of the transcript as input to the second AI model, a question asked by the second participant.

13. The system of claim 12, wherein the operations further comprise:
determining, using the second AI model and using the question asked by the second participant and the first speaker note as input, that the first speaker note answers the question asked by the second participant; and
causing the causing the virtual meeting UI to display the question asked by the second participant at the determined location in the virtual meeting UI.

14. The system of claim 11, wherein:
the virtual meeting UI further comprises a second region corresponding to a presentation of content by the first participant of the plurality of participants; and
causing the virtual meeting UI to display the first speaker note at the determined location is responsive to the presentation of content displaying a predetermined portion of the content.

15. The system of claim 14, wherein:
the content comprises a slide presentation; and
the predetermined portion of the content comprises a predetermined slide of the slide presentation.

16. A non-transitory computer-readable storage medium with instructions that, when executed by a processing device, cause the processing device to perform operations comprising:
causing a virtual meeting user interface (UI) to be presented during a virtual meeting between a plurality of participants, the virtual meeting UI comprising a plurality of first regions each corresponding to a participant of the plurality of participants;
identifying a first speaker note associated with content shared by a first participant of the plurality of participants during the virtual meeting;
determining, using a first artificial intelligence (AI) model and using a representation of the virtual meeting UI as input to the first AI model, a location in the virtual meeting UI for displaying the first speaker note; and
causing the virtual meeting UI to display, on a client device of the first participant, the first speaker note at the determined location in the virtual meeting UI.

17. The non-transitory computer-readable storage medium of claim 16, wherein the determined location comprises a region of the plurality of first regions.

18. The non-transitory computer-readable storage medium of claim 16, wherein:
the virtual meeting UI further comprises a second region corresponding to a presentation of content by the first participant of the plurality of participants; and
the determined location comprises the second region.

19. The non-transitory computer-readable storage medium of claim 16, wherein:
the virtual meeting UI further comprises a second region corresponding to a presentation of content by the first participant of the plurality of participants; and
causing the virtual meeting UI to display the first speaker note at the determined location is responsive to the presentation of content displaying a predetermined portion of the content.

20. The non-transitory computer-readable storage medium of claim 19, wherein:
the content comprises a slide presentation; and
the predetermined portion of the content comprises a predetermined slide of the slide presentation.
